(19) United States
(12) Patent Application Publication
(10) Pub. No.: US 2025/0265787 A1
(43) Pub. Date: Aug. 21, 2025

(54) EXCHANGING AVATAR DATA FOR EXTENDED REALITY (XR) COMMUNICATION SESSIONS

(71) Applicant: QUALCOMM Incorporated, San Diego, CA (US)

(72) Inventors: Imed Bouazizi, Celina, TX (US); Liangping Ma, San Diego, CA (US)

(21) Appl. No.: 19/050,907

(22) Filed: Feb. 11, 2025

Related U.S. Application Data
(60) Provisional application No. 63/553,775, filed on Feb. 15, 2024.

(51) Int. Cl. G06T 19/00; G06T 13/40; H04L 65/403

(52) U.S. Cl. CPC G06T 19/006; G06T 13/40; H04L 65/403; G06T 2219/024

(57) ABSTRACT

An example user equipment (UE) device for retrieving augmented reality (AR) media data includes: a memory configured to store media data of an AR session; and a processing system implemented in circuitry and configured to: receive a scene description for the AR session from a device executing a media function or multimedia resource function (MF/MRF) of a radio access network (RAN) to which the UE device is communicatively coupled, the scene description including data representing how to access avatar data for one or more participants in the AR session; retrieve the avatar data according to the scene description; and present the avatar data to a user of the UE device during the AR session.

This application claims the benefit of U.S. Provisional Application No. 63/553,775, filed Feb. 15, 2024, the entire contents of which are hereby incorporated by reference.

### TECHNICAL FIELD

This disclosure relates to storage and transport of media data.

### BACKGROUND

Extended reality (XR) generally refers to one or more of a variety of techniques by which a computing device may present a three-dimensional (3D) scene to a user. XR may include, for example, augmented reality (AR), mixed reality (MR), or virtual reality (VR). XR may therefore be considered as a generic term for various technologies that alter reality through the addition of digital elements to a physical or real-world environment. AR may refer to presentation of a digital layer over physical elements of the real-world environment. MR may refer to the inclusion of digital elements that may interact with the physical elements. VR may refer to a fully immersive digital environment. In any case, a user may be presented with a 3D scene that the user may navigate and/or interact with.

### SUMMARY

In general, this disclosure describes techniques related to participation in augmented reality (AR) communication sessions. In particular, participants in an AR session may wish to be represented by a digital avatar, which may resemble a user, a different person, a character, or the like. Such avatars may be animated such that when a user physically moves (e.g., speaks or otherwise has facial movements), the facial movements may be imparted to the avatar. Likewise, if the user walks or otherwise moves, such movements may also be imparted to the avatar. Furthermore, the avatar may be modified or enhanced, e.g., to add digital accessories (clothing, costumes, jewelry, or the like) to the avatar. This disclosure describes techniques by which such avatar data may be distributed to participants of an AR session, and techniques by which the avatars may be animated to reflect user movements. In particular, a digital asset repository may store avatar data for user avatars. For example, users may upload avatar data to the digital asset repository, along with authorization data indicating other users who are permitted to access the avatar data. In this manner, avatar data can easily be distributed to participants in the AR session via the digital asset repository, which may reduce latency thereby improving performance of the AR session.

In one example, a method of retrieving augmented reality (AR) media data includes: receiving, by a user equipment (UE) device engaged in an AR session, a scene description for the AR session from a device executing a media function or multimedia resource function (MF/MRF) of a radio access network (RAN) to which the UE device is communicatively coupled, the scene description including data representing how to access avatar data for one or more participants in the AR session; retrieving, by the UE device, the avatar data according to the scene description; and presenting, by the UE device, the avatar data to a user of the UE device during the AR session.

In another example, a user equipment (UE) device for retrieving augmented reality (AR) media data includes: a memory configured to store media data of an AR session; and a processing system implemented in circuitry and configured to: receive a scene description for the AR session from a device executing a media function or multimedia resource function (MF/MRF) of a radio access network (RAN) to which the UE device is communicatively coupled, the scene description including data representing how to access avatar data for one or more participants in the AR session; retrieve the avatar data according to the scene description; and present the avatar data to a user of the UE device during the AR session.

In another example, a method of distributing augmented reality (AR) media data includes: receiving, by an AR application server (AS) device, data for each of a plurality of participants in an AR session indicating that the participant has an avatar to be presented in a scene corresponding to the AR session; generating, by the AR AS device, a scene description for the AR session, the scene description including data representing how to access avatar data for each of the plurality of participants; and sending, by the AR AS and to client devices of the plurality of participants, the scene description.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example network including various devices for performing the techniques of this disclosure.

FIG. 2 is a block diagram illustrating an example computing system that may perform techniques of this disclosure.

FIG. 3 is a conceptual diagram illustrating an example architecture for avatars.

FIG. 4 is a block diagram illustrating an example function map for distribution and use of avatar data in an augmented reality (AR) session according to techniques of this disclosure.

FIG. 5 is a conceptual diagram illustrating an example architecture for distribution and use of avatar data in an AR session according to techniques of this disclosure.

FIG. 6 is a flow diagram illustrating an example method for exchanging avatar data and animating the avatar data according to techniques of this disclosure.

FIG. 7 is a flowchart illustrating an example method for an AR application server (AR AS) to generate and send a scene description representing avatar access data for an AR session per techniques of this disclosure.

FIG. 8 is a flowchart illustrating an example method for a UE device participating in an AR session to retrieve avatar data per techniques of this disclosure.

FIG. 9 is a flowchart illustrating an example method for a digital access repository to authenticate a request for avatar data per techniques of this disclosure.

### DETAILED DESCRIPTION

Augmented reality (AR) calls (or other extended reality (XR) media communication sessions, such as mixed reality (MR) or virtual reality (VR)) may require significant processing resources to render content of the AR call scene, especially when multiple participants contribute to the creation of a complex AR call scene. These scenes may include a virtual environment that may be anchored to a real-world location, as well as content from all participants in the call. Content from a participant may include, for example, user avatars, slide materials, 3D virtual objects, etc.

Physically based rendering (PBR) may be included in rendering AR or other XR data. PBR generally includes rendering image data through emulating light transmission in a virtual world to recreate real world lighting, including user shadows and object reflections on specular surfaces.

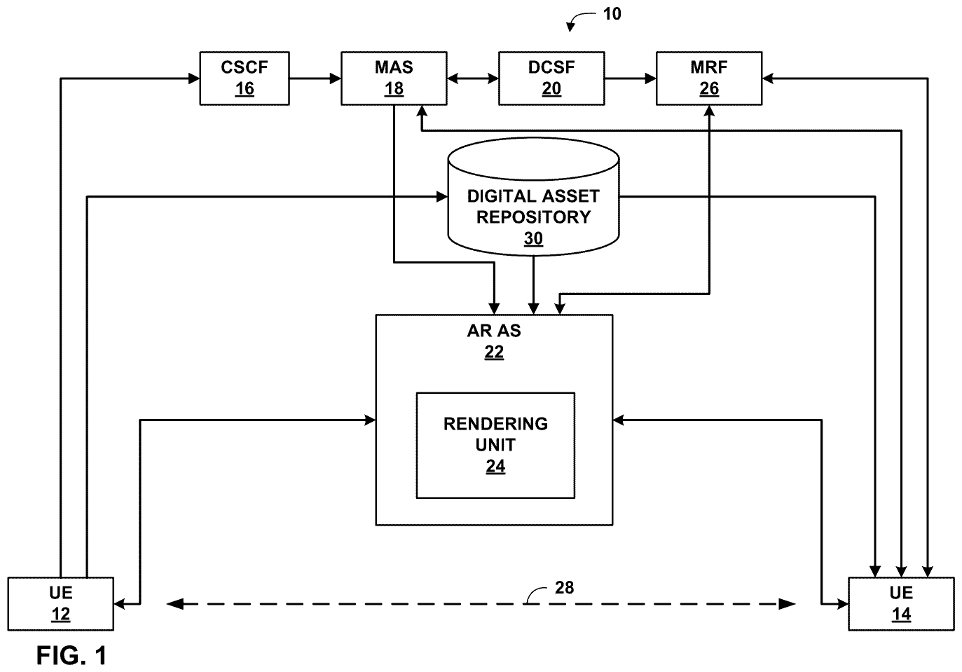

FIG. 1 is a block diagram illustrating an example network 10 including various devices for performing the techniques of this disclosure. In this example, network 10 includes user equipment (UE) devices 12, 14, call session control function (CSCF) 16, multimedia application server (MAS) 18, data channel signaling function (DCSF) 20, multimedia resource function (MRF) 26, augmented reality application server (AR AS) 22, and digital asset repository (DAR) 30. MAS 18 may correspond to a multimedia telephony application server, an IP Multimedia Subsystem (IMS) application server, or the like.

UEs 12, 14 represent examples of UEs that may participate in an AR communication session 28. AR communication session 28 may generally represent a communication session during which users of UEs 12, 14 exchange voice, video, and/or AR data (and/or other XR data). For example, AR communication session 28 may represent a conference call during which the users of UEs 12, 14 may be virtually present in a virtual conference room, which may include a virtual table, virtual chairs, a virtual screen or white board, or other such virtual objects.

The users may be represented by avatars, which may be realistic or cartoonish depictions of the users in the virtual AR scene. Per techniques of this disclosure, a user of UE 12, for example, may store an avatar for the user of UE 12 to digital asset repository 30, along with authorization information indicating that, e.g., UE 14 is authorized to access the avatar. Thus, either AR AS 22 or UE 14 may retrieve the avatar for the user of UE 12 from digital asset repository 30. Then, as part of AR communication session 28, UE 12 may send animation stream data to UE 14 and/or AR AS 22, which may use the animation stream data to animate and render the avatar.

The users may interact with virtual objects, which may cause the virtual objects to move or trigger other behaviors in the virtual scene. Furthermore, the users may navigate through the virtual scene, and a user's corresponding avatar may move according to the user's movements or movement inputs. In some examples, the users' avatars may include faces that are animated according to the facial movements of the users (e.g., to represent speech or emotions, e.g., smiling, thinking, frowning, or the like).

UEs 12, 14 may exchange AR media data related to a virtual scene, represented by a scene description. Users of UEs 12, 14 may view the virtual scene including virtual objects, as well as user AR data, such as avatars, shadows cast by the avatars, user virtual objects, user provided documents such as slides, images, videos, or the like, or other such data. Ultimately, users of UEs 12, 14 may experience an AR call from the perspective of their corresponding avatars (in first or third person) of virtual objects and avatars in the scene.

UEs 12, 14 may collect pose data for users of UEs 12, 14, respectively. For example, UEs 12, 14 may collect pose data including a position of the users, corresponding to positions within the virtual scene, as well as an orientation of a viewport, such as a direction in which the users are looking (i.e., an orientation of UEs 12, 14 in the real world, corresponding to virtual camera orientations). UEs 12, 14 may provide this pose data to AR AS 22 and/or to each other.

CSCF 16 may be a proxy CSCF (P-CSCF), an interrogating CSCF (I-CSCF), or serving CSCF (S-CSCF). CSCF 16 may generally authenticate users of UEs 12 and/or 14, inspect signaling for proper use, provide quality of service (QoS), provide policy enforcement, participate in session initiation protocol (SIP) communications, provide session control, direct messages to appropriate application server(s), provide routing services, or the like. CSCF 16 may represent one or more I/S/P CSCFs.

MAS 18 represents an application server for providing voice, video, and other telephony services over a network, such as a 5G network. MAS 18 may provide telephony applications and multimedia functions to UEs 12, 14.

DCSF 20 may act as an interface between MAS 18 and MRF 26, to request data channel resources from MRF 26 and to confirm that data channel resources have been allocated. DCSF 20 may receive event reports from MAS 18 and determine whether an AR communication service is permitted to be present during a communication session (e.g., an IMS communication session).

MRF 26 may be an enhanced MRF (eMRF) in some examples. In general, MRF 26 generates scene descriptions for each participant in an AR communication session. MRF 26 may support an AR conversational service, e.g., including providing transcoding for terminals with limited capabilities. MRF 26 may collect spatial and media descriptions from UEs 12, 14 and create scene descriptions for symmetrical AR call experiences. In some examples, rendering unit 24 may be included in MRF 26 instead of AR AS 22, such that MRF 26 may provide remote AR rendering services, as discussed in greater detail below.

MRF 26 may request data from UEs 12, 14 to create a symmetric experience for users of UEs 12, 14. The requested data may include, for example, a spatial description of a space around UEs 12, 14; media properties representing AR media that each of UEs 12, 14 will be sending to be incorporated into the scene; receiving media capabilities of UEs 12, 14 (e.g., decoding and rendering/hardware capabilities, such as a display resolution); and information based on detecting location, orientation, and capabilities of physical world devices that may be used in an audio-visual communication sessions. Based on this data, MRF 26 may create a scene that defines placement of each user and AR media in the scene (e.g., position, size, depth from the user, anchor type, and recommended resolution/quality); and specific rendering properties for AR media data (e.g., if 2D media should be rendered with a “billboarding” effect such that the 2D media is always facing the user). MRF 26 may send the scene data to each of UEs 12, 14 using a supported scene description format.

AR AS 22 may participate in AR communication session 28. For example, AR AS 22 may provide AR service control related to AR communication session 28. AR service control may include AR session media control and AR media capability negotiation between UEs 12, 14 and rendering unit 24.

AR AS 22 also includes rendering unit 24, in this example. Rendering unit 24 may perform split rendering on behalf of at least one of UEs 12, 14. In some examples, two different rendering units may be provided. In general, rendering unit 24 may perform a first set of rendering tasks for, e.g., UE 14, and UE 14 may complete the rendering process, which may include warping rendered viewport data to correspond to a current view of a user of UE 14. For example, UE 14 may send a predicted pose (position and orientation) of the user to rendering unit 24, and rendering unit 24 may render a viewport according to the predicted pose. However, if the actual pose is different than the predicted pose at the time video data is to be presented to a user of UE 14, UE 14 may warp the rendered data to represent the actual pose (e.g., if the user has suddenly changed movement direction or turned their head).

While only a single rendering unit is shown in the example of FIG. 1, in other examples, each of UEs 12, 14 may be associated with a corresponding rendering unit. Rendering unit 24 as shown in the example of FIG. 1 is included in AR AS 22, which may be an edge server at an edge of a communication network. However, in other examples, rendering unit 24 may be included in a local network of, e.g., UE 12 or UE 14. For example, rendering unit 24 may be included in a PC, laptop, tablet, or cellular phone of a user, and UE 14 may correspond to a wireless display device, e.g., AR/VR/MR/XR glasses or head mounted display (HMD). Although two UEs are shown in the example of FIG. 1, in general, multi-participant AR calls are also possible.

UEs 12, 14, and AR AS 22 may communicate AR data using a network communication protocol, such as Real-time Transport Protocol (RTP), which is standardized in Request for Comment (RFC) 3550 by the Internet Engineering Task Force (IETF). These and other devices involved in RTP communications may also implement protocols related to RTP, such as RTP Control Protocol (RTCP), Real-time Streaming Protocol (RTSP), Session Initiation Protocol (SIP), and/or Session Description Protocol (SDP).

In general, an RTP session may be established as follows. UE 12, for example, may receive an RTSP describe request from, e.g., UE 14. The RTSP describe request may include data indicating what types of data are supported by UE 14. UE 12 may respond to UE 14 with data indicating media streams that can be sent to UE 14, along with a corresponding network location identifier, such as a uniform resource locator (URL) or uniform resource name (URN).

UE 12 may then receive an RTSP setup request from UE 14. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on UE 14. UE 12 may reply to the RTSP setup request with a confirmation and data representing ports of UE 12 by which the RTP data and control data will be sent. UE 12 may then receive an RTSP play request, to cause the media stream to be “played,” i.e., sent to UE 14. UE 12 may also receive an RTSP teardown request to end the streaming session, in response to which, UE 12 may stop sending media data to UE 14 for the corresponding session.

UE 14, likewise, may initiate a media stream by initially sending an RTSP describe request to UE 12. The RTSP describe request may indicate types of data supported by UE 14. UE 14 may then receive a reply from UE 12 specifying available media streams, such as media content 64, that can be sent to UE 14, along with a corresponding network location identifier, such as a uniform resource locator (URL) or uniform resource name (URN).

UE 14 may then generate an RTSP setup request and send the RTSP setup request to UE 12. As noted above, the RTSP setup request may contain the network location identifier for the requested media data (e.g., media content 64) and a transport specifier, such as local ports for receiving RTP data and control data (e.g., RTCP data) on UE 14. In response, UE 14 may receive a confirmation from UE 12, including ports of UE 12 that UE 12 will use to send media data and control data.

After establishing a media streaming session (e.g., AR communication session 28) between UE 12 and UE 14, UE 12 exchange media data (e.g., packets of media data) with UE 14 according to the media streaming session. UE 12 and UE 14 may exchange control data (e.g., RTCP data) indicating, for example, reception statistics by UE 14, such that UEs 12, 14 can perform congestion control or otherwise diagnose and address transmission faults.

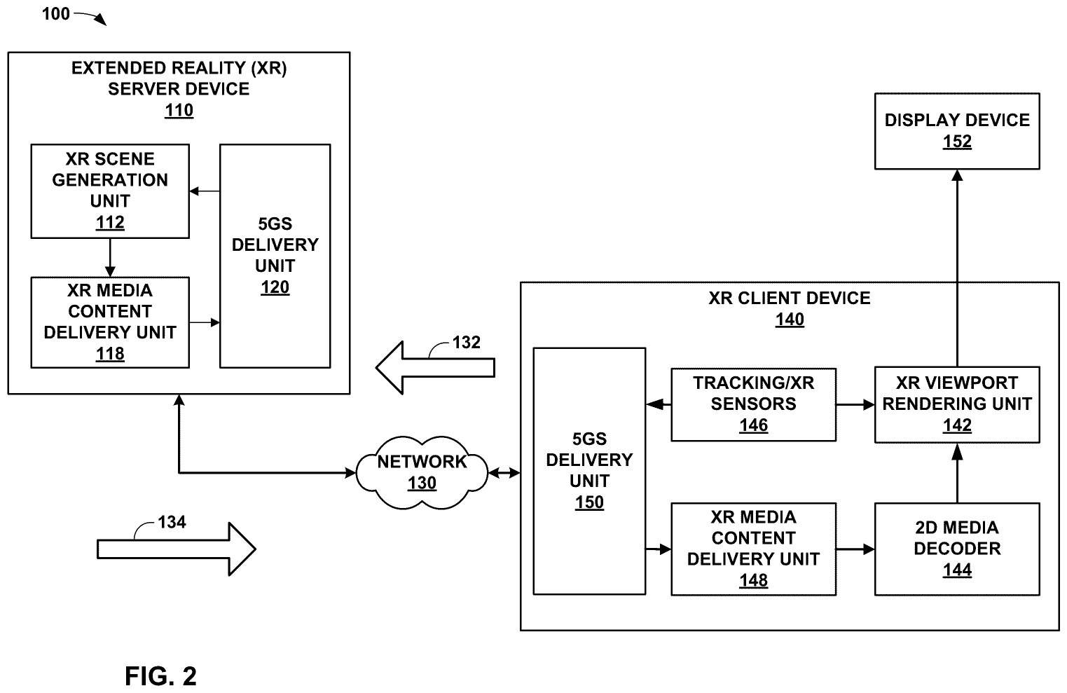

FIG. 2 is a block diagram illustrating an example computing system 100 that may perform techniques of this disclosure. In this example, computing system 100 includes extended reality (XR) server device 110, network 130, XR client device 140, and display device 152. XR server device 110 includes XR scene generation unit 112, XR media content delivery unit 118, and 5G System (5GS) delivery unit 120. Network 130 may correspond to any network of computing devices that communicate according to one or more network protocols, such as the Internet. In particular, network 130 may include a 5G radio access network (RAN) including an access device to which XR client device 140 connects to access network 130 and XR server device 110. In other examples, other types of networks, such as other types of RANs, may be used. XR client device 140 includes 5GS delivery unit 150, tracking/XR sensors 146, XR viewport rendering unit 142, 2D media decoder 144, and XR media content delivery unit 148. XR client device 140 also interfaces with display device 152 to present XR media data to a user (not shown).

In some examples, XR scene generation unit 112 may correspond to an interactive media entertainment application, such as a video game, which may be executed by one or more processors implemented in circuitry of XR server device 110. XR media content delivery unit 118 represents a content delivery sender, in this example. In this example, XR media content delivery unit 148 represents a content delivery receiver, and 2D media decoder 144 may perform error handling.

In general, XR client device 140 may determine a user's viewport, e.g., a direction in which a user is looking and a physical location of the user, which may correspond to an orientation of XR client device 140 and a geographic position of XR client device 140. Tracking/XR sensors 146 may determine such location and orientation data, e.g., using cameras, accelerometers, magnetometers, gyroscopes, or the like. Tracking/XR sensors 146 provide location and orientation data to XR viewport rendering unit 142 and 5GS delivery unit 150. XR viewport rendering unit 142 may use the location and orientation data to complete an XR rendering process. XR client device 140 provides tracking and sensor information 132 to XR server device 110 via network 130. XR server device 110, in turn, receives tracking and sensor information 132 and provides this information to XR scene generation unit 112. In this manner, XR scene generation unit 112 can generate scene data for the user's viewport and location.

XR server device 110 may further send scene description data and other XR data to XR client device 140, in the form of data 134. Data 134 may represent data for other users, such as avatar data for the other users, animation data for the avatar data, scene modification data (e.g., indications that virtual objects have moved in the virtual scene), animations, sound, or other such data.

Per the techniques of this disclosure, XR client device 140 may send avatar data to XR server device 110 or another device via network 130. XR client device 140 may also send data representing movements to be imparted to the avatar data during an AR/XR session in the form of animation stream data. XR server device 110 or another device, as explained in greater detain below, may forward such animation stream data to other participants in the AR/XR session or render the avatar data for XR client device 140 on behalf of the other participants.

In general, the techniques of this disclosure are directed to supporting distribution and use of avatar data during an AR/XR session. The techniques of this disclosure may generally be used to satisfy any or all of the following goals: defining and identifying the impacts from avatar communication between two or more users in the context of IP Multimedia Subsystems (IMS); providing identifiers required for IMS avatar communication, e.g., identifiers for an avatar representation in IMS, and the association of an avatar representation with a user; indicating whether and how avatar objects, such as an avatar representation, are stored and accessed by authenticated and authorized UE and/or IMS network nodes avoiding fraud and ensuring privacy; indicating whether and how to authorize the use of an avatar representation in an IMS avatar communication; indicating whether and how to enable service/capability negotiation between UE and IMS network (which may include service/capability negotiation to enable transition, transcoding, and rendering of media in an avatar communication); indicating how to enable transition and transcoding between MMTel session using audio/video codec and IMS avatar based communication (which may use a special avatar codec); indicating how to enable transcoding between speech and gesture (or text) in an IMS avatar communication; and indicating how to enable UE based and network-based rendering in case of IMS avatar communication.

These techniques may support transition, transcoding, and service/capability negotiation aspects in coordination with SA WG4. This disclosure describes techniques that may address these aspects in a way that aligns with the SA4 progress on avatar and their identified avatar reference architecture.

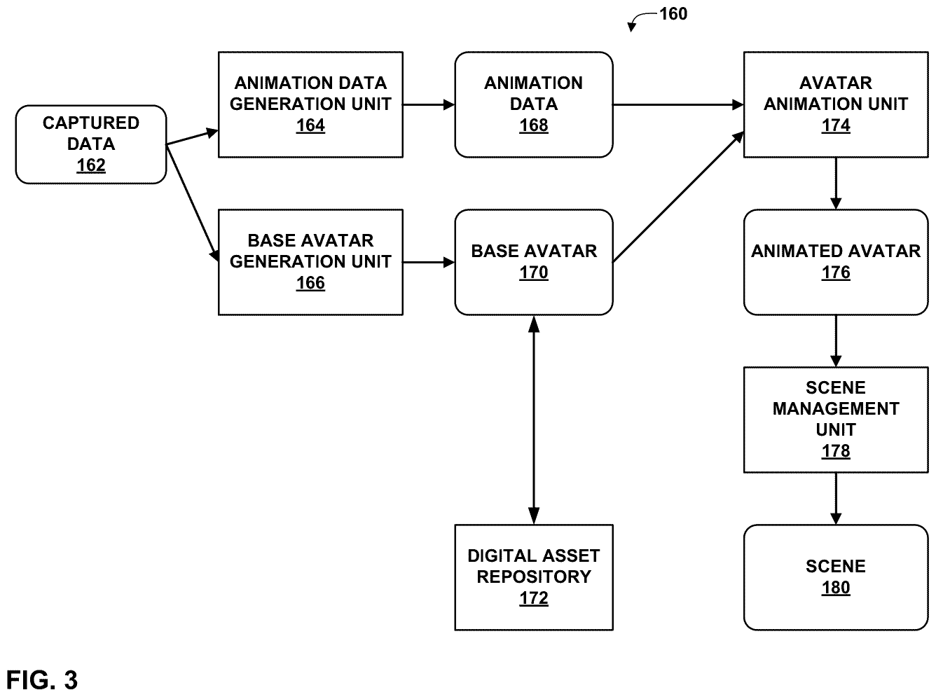

FIG. 3 is a block diagram illustrating an example architecture 160 for exchanging, animating, and rendering avatar data. In this example, architecture 160 includes base avatar generation unit 166, animation data generation unit 164, digital asset repository 172, avatar animation unit 174, and scene management unit 178.

Base avatar generation unit 166 generates base avatar 170 from inputs, such as captured video from camera and other sensors information. This may be done online or offline.

Animation data generation unit 164 generates animation data 168 from raw signals. The raw signals may come from cameras, microphones, specialized motion capturing devices, or the like. For example, through the current functional element, video captured by a camera can be converted into facial feature points, and the audio captured by the microphone can be converted into text.

Digital asset repository 172 represents an entity that offers storage of base avatars, such as base avatar 170. Digital asset repository 172 may be offered by a 5G System, a 3^{rd} party entity, or local storage of user devices. Digital asset repository 172 may ensure proper access to base avatar 170 and any related data, including authorization of avatar usage rights. The Authentication functionality may map and identify ownership of an avatar.

Avatar animation unit 174 may, depending on the avatar representation format, retrieve base avatar 170, receive representation format-specific animation data streams, and perform avatar animation to produce animated avatar 176 that will be used in a rendering process. Some animation approaches may not need to rely on base avatar 170, but instead may directly produce a rendered 2D view of the avatar.

Scene management unit 178 creates and composes a shared 3D scene 180 for all participants of an AR/XR session. Scene management unit 178 may integrate a description of base avatar 170 and update the position and orientation of a presentation of the avatar based on user pose data. Scene management unit 178 may share the updated scene with all participants in the AR/XR session, which includes presentations of scene 180.

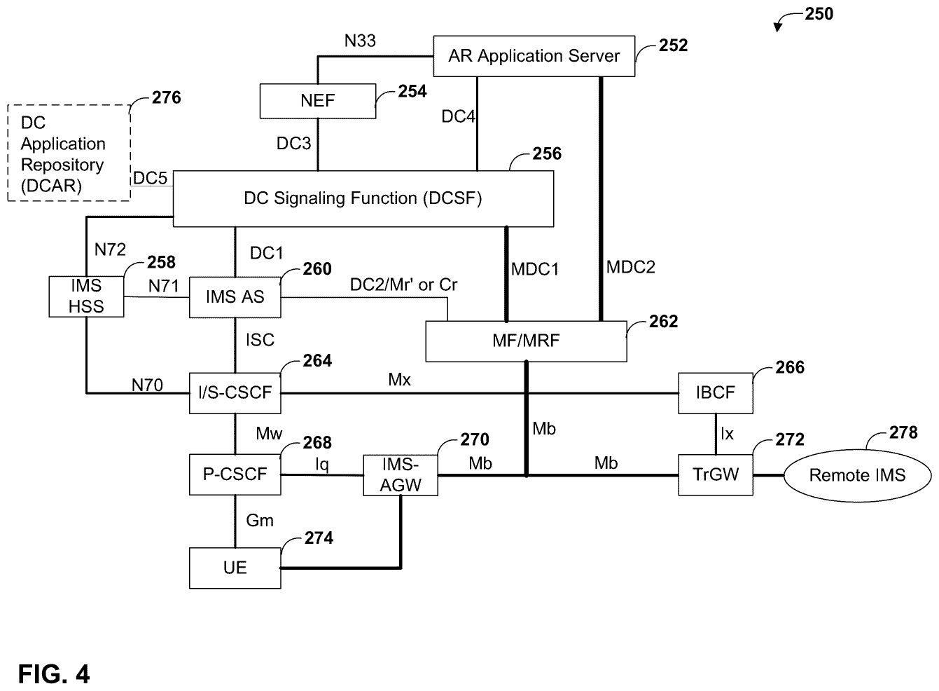

FIG. 4 is a block diagram illustrating an example IP Multimedia Subsystem (IMS) architecture 250 for distribution and use of avatar data in an AR/XR session according to techniques of this disclosure. In this example, IMS architecture 250 includes augmented reality (AR) application server (AS) 252 (which may also be referred to as an “XR application server”), network exposure function (NEF) 254, data channel (DC) signaling function (DCSF) 256, IP multimedia subsystem (IMS) home subscriber system (HSS) 258, IMS AS 260, a device executing a media function or multimedia resource function (MF/MRF) 262, I/S-call session control function (CSCF) 264, interconnection border control function (IBCF) 266, P-CSCF 268, IMS access gateway (AGW) 270, transition gateway (TrGW) 272, user equipment (UE) device 274, DC application repository (DCAR) 276, and a remote IP Multimedia Subsystem (IMS) 278, to which a second, different UE may be communicatively coupled. UE 274 and the second, different UE of remote IMS 278 may participate in an AR/XR session.

Per the techniques of this disclosure, AR Application Server 252 may set up an AR/XR scene for the AR/XR session and add participant avatars to the scene. AR AS 252 may perform the functionality of Scene Management. AR Application Server 252 may create and update the scene description. AR AS 252 may receive, from each participant that desires to add an avatar, information about access to the avatar. AR AS 252 may then update the scene description to include data for accessing the avatars of each participant (e.g., network locations of a storage device or system, such as uniform resource locator(s) (URLs)) and distributes the updated scene description to all participants. This exchange happens over the data channel via MF/MRF device 262.

Per the techniques of this disclosure, avatar storage functionality is mapped to a new network function, the Digital Asset Repository (DAR) (not shown in FIG. 4). The DAR stores base avatar models together with all associated digital assets, such as personalized accessories and garments. The user may at any time prior to a call (AR/XR session) update their avatar, add/remove accessories, and set their default look. At the start of a call, the user may decide to change the selected accessories and garments. The DAR ensures that only appropriate and authorized access to the subset of data that is used by other participants for the user's avatar. The base avatar generation function is assumed to be done at the UE or in the cloud using 3^{rd} party services and is not reflected in the IMS architecture. Once the base avatar model is generated, the base avatar model may be uploaded by UE 274 to the DAR, which verifies the compatibility of the avatar and associates the avatar with the user credentials.

The avatar animation function, if performed in the network, may be performed by MF/MRF device 262. Alternatively, the avatar animation function may be performed solely by UE device 274 or as a split rendering process between MF/MRF device 262 and UE device 274.

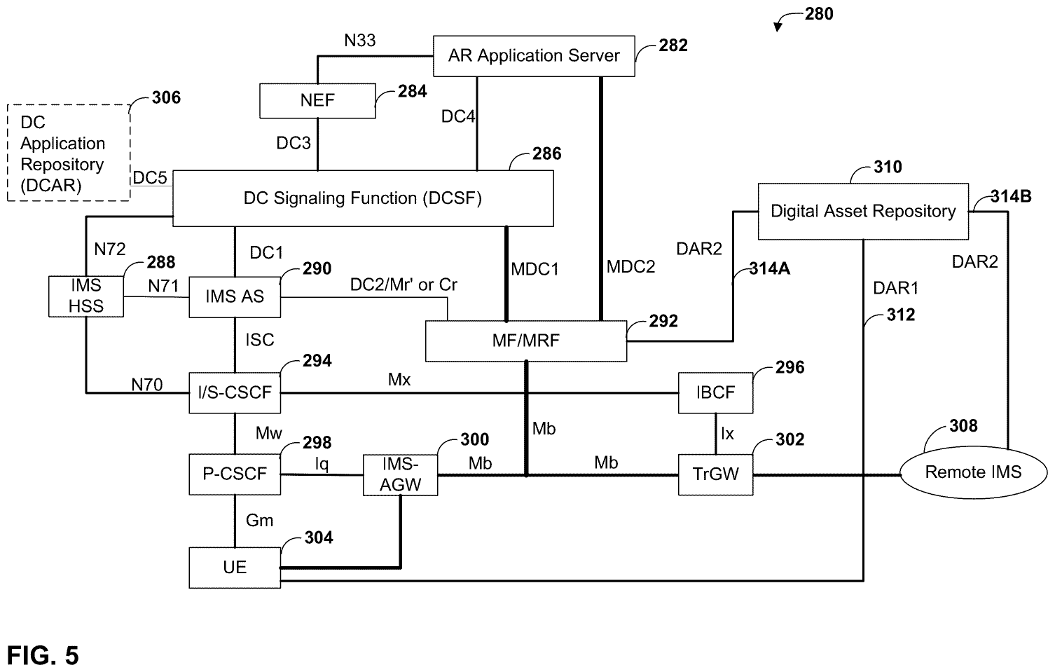

FIG. 5 is a conceptual diagram illustrating an example IP Multimedia Subsystem (IMS) architecture 280 for distribution and use of avatar data in an AR/XR session according to techniques of this disclosure. In this example, IMS architecture 280 includes AR application server (AS) 282, network exposure function (NEF) 284, data channel (DC) signaling function (DCSF) 286, IP multimedia subsystem (IMS) home subscriber system (HSS) 288, IMS AS 290, media function/multimedia resource function (MF/MRF) device 292, I/S-call session control function (CSCF) 294, interconnection border control function (IBCF) 296, P-CSCF 298, IMS access gateway (AGW) 300, transition gateway (TrGW) 302, user equipment (UE) device 304, DC application repository (DCAR) 306, remote IMS 308, and digital asset repository (DAR) device 310. A second, different UE device than UE device 304 may be communicatively coupled to remote IMS 308. UE device 304 and the second, different UE device may participate in a common AR/XR session.

DAR device 310 may store avatar assets, which may include a base avatar model and any personalized accessories. The assets may be associated with a particular user and access to them may be restricted. The owner may update the assets that are stored in DAR device 310. Participants in an AR/XR call may be authorized to access the base avatar and a selected subset of accessories during the lifetime of the call (XR session). Thus, DAR device 310 may store original and/or updated avatar representations. DAR device 310 may also receive and address requests for avatar representations. DAR device 310 may authorize access to avatar representations. DAR device 310 may also share avatar representations (e.g., to authorized UEs).

MF/MRF device 262 may receive animation streams, send animation streams and/or generate animation streams from received media data. MF/MRF device 262 may animate and/or reconstruct a UE user's avatar (that is, the avatar of a participant in an AR/XR session).

Architecture 280 also depicts reference points DAR1 312 and DAR2 314. DAR1 312 is a reference point between UE 304 and DAR device 310. DAR1 312 may be used by UE 304 to upload and update the base avatar model and associated accessories to DAR device 310. UE 304 uses DAR1 312 to set the default avatar configuration for future AR calls (e.g., which garments the avatar has on). This configuration may also be updated at the start or during an ongoing AR call. DAR1 312 may also be used to temporarily authorize other participants to access the selected subset of the avatar for the AR call.

A reference point may exist between DAR 310 and UE 304 (DAR2 314B) or between DAR 310 and MF/MRF device 292 (DAR2 314A) to access the base avatar model of another participant at the start of or during an AR call. The assets may be accessed separately and at different levels of detail. The access is restricted to authorized users. This authorization may include the necessary decryption keys/licenses to decrypt the avatar assets.

Both DAR1 312 and DAR2 314A/B reference points may use HTTPS with appropriate authorization mechanisms, such as OAuth 2.0.

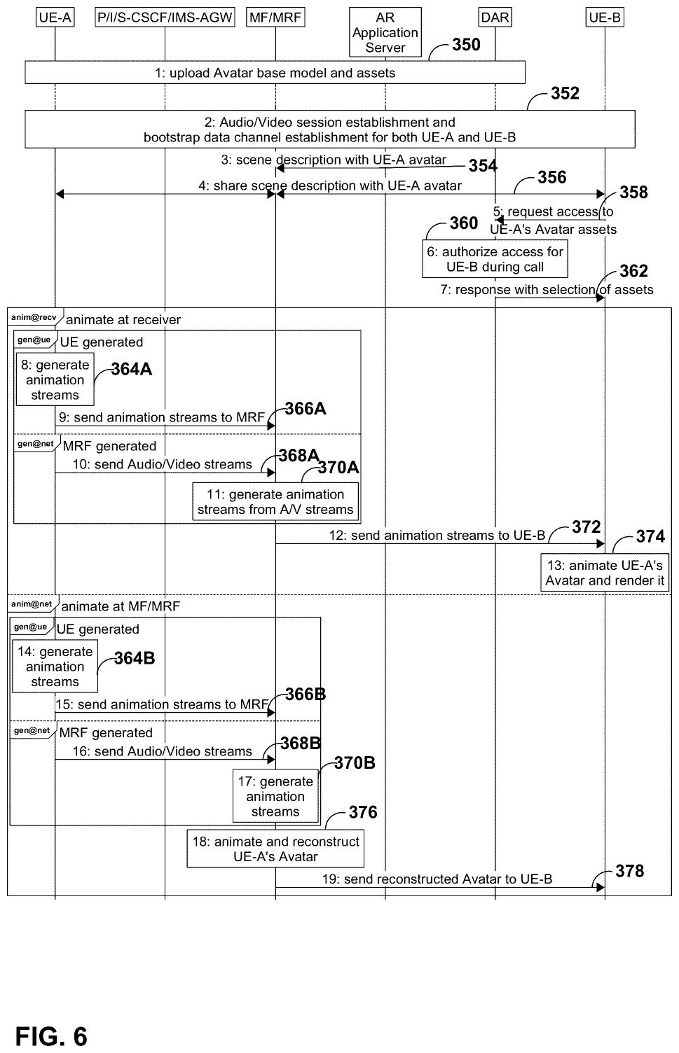

FIG. 6 is a flow diagram illustrating an example method for exchanging avatar data and animating the avatar data according to techniques of this disclosure. This example method is based on the following assumptions: 1) animation of the Avatar is either done on the receiving UE (UE-B) or is delegated to the MF/MRF; and 2) network rendering is not performed but can easily be added as an independent step to the AR call.

In the example method of FIG. 6, initially, UE-A generates or updates a conformant avatar representation of a user of UE-A and uploads the avatar to the Digital Asset Repository (350). The representation may include the avatar base model as well as other accessories, such as garments. UE-A may upgrade each of the components independently.

UE-A and UE-B then establishes an IMS session that includes audio, video, and a bootstrap data channel that is used to distribute the initial scene description to both participants (352).

The AR Application Server generates the scene description for the AR session and sends the scene description over the data channel to the MF/MRF (354). The scene description may include an avatar representation of UE-A and UE-B. The AR Application Server may update the scene during the lifetime of the IMS session by sending scene updates to the receivers.

The MF/MRF then forwards the scene description to UE-A and UE-B (356). Each participant may share their own proposed updates to the scene, e.g. by adding new nodes.

UE-B processes the scene description to determine the presence of the avatar for UE-A in the scene. UE-B then sends a request to the Digital Asset Repository to access UE-A's avatar base model (358).

The Digital Asset Repository authorizes UE-B's access to UE-A's Avatar base model for the duration of the call (360). This step may involve the checking of the IMS session details and the authentication of UE-B. This step may also include checking which assets and which level of details are to be shared.

If successfully authorized, the Digital Asset Repository shares the selected subset of UE-A's Avatar base model and assets with UE-B (362).

Steps 358-362 may be considered optional and may be performed between MF/MRF and DAR, in case the animation is performed at the MF/MRF instead of at UE-B.

FIG. 6 depicts two example options for the animation process shown in FIG. 6. In the first example, UE-B animates the avatar directly. In the second example, the MF/MRF device partially or fully animates the avatar and sends the partially or fully animated avatar to UE-B.

For animation at the receiver (UE-B), in case the animation streams are generated at the sender (UE-A), UE-A uses its input data, e.g., camera feeds and the user voice to generate the animation streams (364A). UE-A then sends the animation streams to the MF/MRF (366A). Alternatively, UE-A may send the media streams that are used to generate the animation streams directly to the MF/MRF (368A). These streams may include video streams from user's cameras and/or user's captured audio streams. In that case, the MF/MRF generates the animation streams from the received media streams (370A). In either case, the MF/MRF may then send the animation streams, received from UE-A or generated itself, to UE-B (372). UE-B may then animate and render UE-A's avatar based on the downloaded Avatar base model and the received animation streams and then renders the avatar as part of the scene (374).

For animation at the MF/MRF device, in case the animation streams are generated at the sender (UE-A), UE-A uses its input data, e.g., the camera feeds and the user voice to generate the animation streams (364B). UE-A then sends the animation streams to the MF/MRF (366B). Alternatively, UE-A may send the media streams that are used to generate the animation streams to the MF/MRF (368B). These streams may include video streams from user's cameras and/or user's captured audio streams. In that case, the MF/MRF generates the animation streams from the received media streams (370B). The MF/MRF then animates and reconstructs UE-A's Avatar using the animation streams to match the current user's body pose and facial expressions (376). The output of this step may be a retargeted 3D mesh. The MF/MRF device may then send the reconstructed 3D avatar to UE-B for rendering (378).

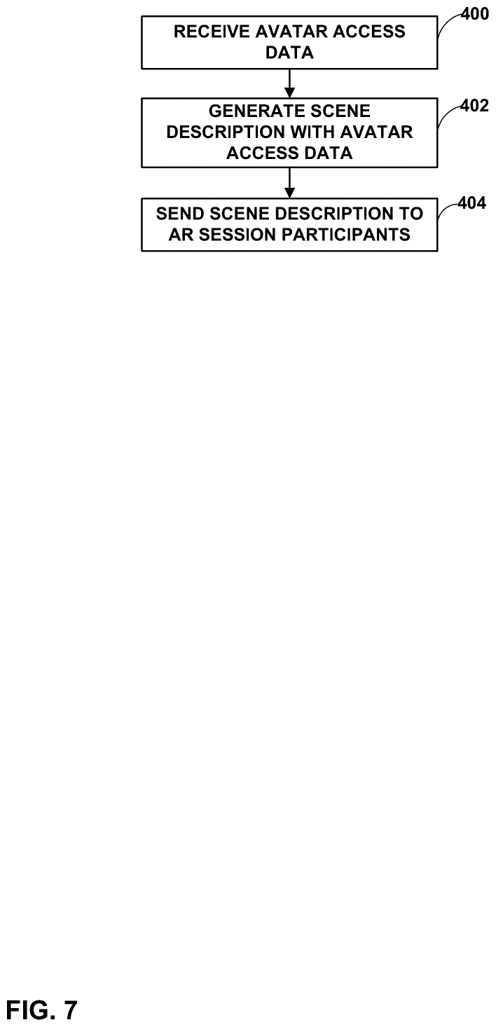

FIG. 7 is a flowchart illustrating an example method for an AR application server (AR AS) to generate and send a scene description representing avatar access data for an AR session per techniques of this disclosure. The method of FIG. 7 may be performed by AR AS 22 of FIG. 1, AR AS 252 of FIG. 4, AR AS 282 of FIG. 5, or another such application server device.

Initially, the AR AS may receive avatar access data (400). The avatar access data may include data for a particular AR session and data indicating identifiers of participants in the AR session who are authorized to access the avatar data. For example, a user of UE 12 of FIG. 1 may provide data indicating that an avatar of the user of UE 12 can be accessed by a user of UE 14 of FIG. 1.

The AR AS may then generate a scene description for the AR session to include avatar access data for the avatar data (402). As discussed above, the scene description may generally describe a shared virtual space (i.e., a virtual scene) to be presented during the AR session in which avatars for participants in the AR session can be seen. Likewise, users may interact with virtual objects and each other in the shared virtual space. Moreover, per techniques of this disclosure, the scene description may include avatar access data. For example, the scene description may include a network location, e.g., a URL, for a digital asset repository from which the avatar data can be retrieved. Although only a single user avatar is described in this example, the scene description may include data for accessing avatars for any or all participants in the AR session. The avatar data for the participants may be stored at a common digital asset repository or may be stored at two or more distinct digital asset repositories. In some examples, one or more participants may store avatar data to one or more digital asset repositories while other participants may send avatar data directly to other participants. The scene description may indicate how to access each avatar of each participant in the AR session.

The AR AS may then send the scene description to each of the participants in the AR session (404). In this manner, the AR AS can provide information to each of the participants on how to access avatar data for other participants in the AR session. Respective UE devices for the participants may automatically process the scene description and retrieve the avatar data and assets, as discussed herein.

In this manner, the method of FIG. 7 represents an example of a method including receiving, by an XR application server (AS) device, data for each of a plurality of participants in an XR session indicating that the participant has an avatar to be presented in a scene corresponding to the XR session; generating, by the XR AS device, a scene description for the XR session, the scene description including data representing how to access avatar data for each of the plurality of participants; and sending, by the XR AS and to client devices of the plurality of participants, the scene description.

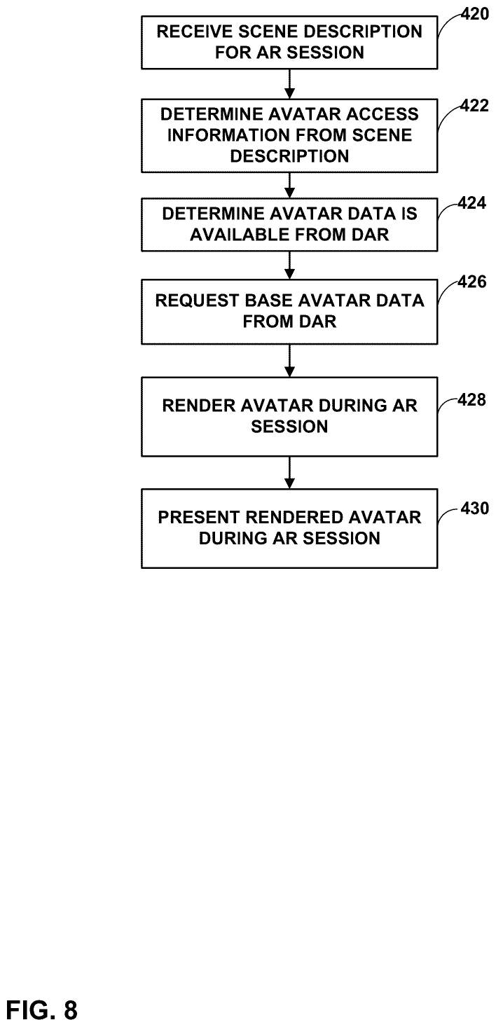

FIG. 8 is a flowchart illustrating an example method for a UE device participating in an AR session to retrieve avatar data per techniques of this disclosure. The method of FIG. 8 may be performed by a UE device, such as UEs 12, 14 of FIG. 1, XR client device 140 of FIG. 2, a UE coupled to remote IMS 278 of FIG. 4, a UE coupled to remote IMS 308 of FIG. 5, or other such UE device.

Initially, a UE may establish an audio/video session with one or more other UEs, e.g., as discussed with respect to step 352 of FIG. 6. The UE may then receive a scene description including data for an AR session which includes data for accessing avatar data of another UE for another participant in the AR session from, e.g., an AR AS device (420). The UE may then extract avatar access information from the scene description (422). For example, the UE may determine that the avatar data is available from a digital asset repository (424). Thus, the UE may determine a network location (e.g., URL) for the digital asset repository storing avatar data and assets for the other participant in the AR session.

The UE may send a request to the digital asset repository for base avatar data and assets for the avatar from the digital asset repository (426). The UE may provide authentication and authorization data to the digital asset repository in the request. In some examples, the request may specify certain assets and levels of detail for the assets.

Assuming the digital asset repository authenticates the UE, the UE may receive the avatar from the digital asset repository. Additionally or alternatively, an MF/MRF device in communication with the UE may request the avatar data on behalf of the UE and perform initial animation and rendering of the avatar using animation stream data as part of a split rendering procedure. Alternatively, the UE may perform animation and rendering of the avatar without the use of the MF/MRF device. In either case, the UE may render the avatar based on animation stream data during the AR session (428). Furthermore, the UE may present the rendered avatar during the AR session (430).

Although not shown in FIG. 8, a user of the UE may also have their own avatar to be presented during the AR session. Thus, the UE may upload avatar data for the avatar to the digital asset repository, or a different digital asset repository. The UE may send access data representing the digital asset repository to an AR AS device (e.g., the same AR AS device from which the scene description is received).

In this manner, the method of FIG. 8 represents an example of a method of retrieving augmented reality (AR) media data, the method including: receiving, by a user equipment (UE) device engaged in an AR session, a scene description for the AR session from a device executing a media function or multimedia resource function (MF/MRF) of a radio access network (RAN) to which the UE device is communicatively coupled, the scene description including data representing how to access avatar data for one or more participants in the AR session; retrieving, by the UE device, the avatar data according to the scene description; and presenting, by the UE device, the avatar data to a user of the UE device during the AR session.

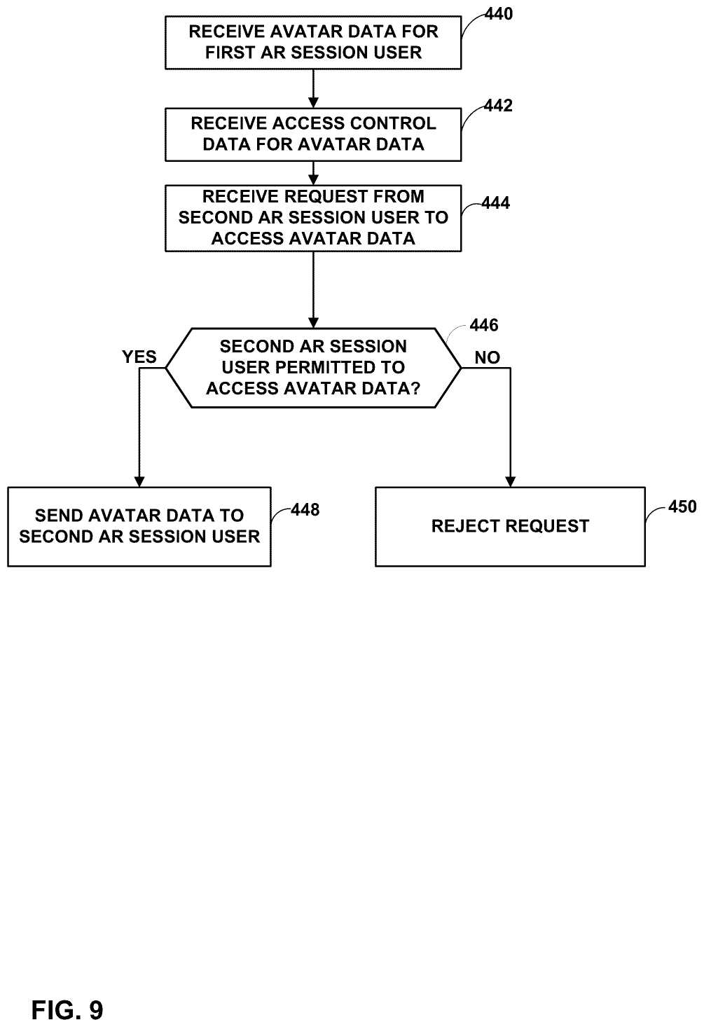

FIG. 9 is a flowchart illustrating an example method for a digital access repository to authenticate a request for avatar data per techniques of this disclosure. The method of FIG. 9 may be performed by a digital asset repository, such as DAR 30 of FIG. 1, digital asset repository 172 of FIG. 3, or digital asset repository 310 of FIG. 5.

Initially, a digital asset repository may receive avatar data for a first AR session user (440). In particular, the digital asset repository may receive the avatar data from a UE device used by the user. The digital asset repository may receive avatar data for multiple different users of a common AR session.

The digital asset repository may further receive access control data for the avatar data (442). The access control data may include data indicating other users who are authorized to access the avatar data for an avatar of a particular user. Such data may include authentication and authorization information, such as an email address, login credentials, user identifier, IP address, MAC address, access token, or the like.

The digital asset repository may then receive a request from a second AR session user to access avatar data of the first AR session user (444). The digital asset repository may determine whether the second AR session user is permitted (authorized) to access the avatar data based on the access control data received from the first AR session user for the avatar data (446). If the second AR session user is permitted to access the avatar data (“YES” branch of 446), the digital asset repository may send the avatar data to the second AR session user. In particular, the request may specify assets of the avatar data to be retrieved and a level of detail for the assets, in which case the digital asset repository may send the requested assets at the requested level of detail. However, if the second AR session user is not permitted to access the avatar data (“NO” branch of 446), the digital access repository may reject the request (450).

In this manner, the method of FIG. 9 represents an example of a method of distributing extended reality (XR) media data, the method including: receiving, by a digital avatar repository (DAR) device, avatar data of a first XR session user; receiving, by the DAR device, a request to access the avatar data by a second XR session user; and sending, by the DAR device, the avatar data to a client device of the second XR session user.

The following clauses represent various examples of the techniques of this disclosure:
Clause 1: A method of distributing extended reality (XR) media data, the method comprising: receiving, by an application server (AS) device, data for each of a plurality of participants in an XR session indicating that the participant has an avatar to be presented in a scene corresponding to the XR session; generating, by the AS device, a scene description for the XR session, the scene description including data representing how to access avatar data for each of the plurality of participants; and sending, by the AS and to client devices of the plurality of participants, the scene description.
Clause 2: The method of clause 1, wherein sending the scene description comprises sending the scene description via a device executing a media function (MF) or a multimedia resource function (MFR).
Clause 3: The method of any of clauses 1 and 2, wherein the data representing how to access the avatar data comprises data representing a network location of a digital asset repository (DAR) device storing the avatar data.
Clause 4: A method of distributing extended reality (XR) media data, the method comprising: receiving, by a digital avatar repository (DAR) device, avatar data of a first XR session user; receiving, by the DAR device, a request to access the avatar data by a second XR session user; and sending, by the DAR device, the avatar data to a client device of the second XR session user.
Clause 5: The method of clause 4, wherein receiving the avatar data of the first XR session user includes receiving data indicating that the second XR session user is authorized to access the avatar data.
Clause 6: The method of any of clauses 4 and 5, wherein receiving the request to access the avatar data comprises receiving authentication data for the second XR session user, and wherein sending the avatar data comprises sending the avatar data in response to authenticating the second XR session user.
Clause 7: A method of distributing extended reality (XR) media data, the method comprising: receiving, by a device executing a media function (MF) or multimedia resource function (MRF), a scene description for an XR session between a first XR session user and a second XR session user, the scene description including data representative of avatar data for the first XR session user; receiving, by the device executing the MF/MRF, an animation stream from the first XR session user; and sending, by the device executing the MF/MRF, data representative of the animation stream and the avatar data to a client device of the second XR session user.
Clause 8: The method of clause 7, wherein the data representative of the animation stream comprises the animation stream.
Clause 9: The method of clause 7, further comprising animating the avatar data to generate the data representative of the animation stream, the data representative of the animation stream comprising animated avatar data.
Clause 10: A device for distributed extended reality (XR) media data, the device comprising one or more means for performing the method of any of clauses 1-9.
Clause 11: An application server (AS) device for distributing extended reality (XR) media data, the AS device comprising: means for receiving data for each of a plurality of participants in an XR session indicating that the participant has an avatar to be presented in a scene corresponding to the XR session; means for generating a scene description for the XR session, the scene description including data representing how to access avatar data for each of the plurality of participants; and means for sending, to client devices of the plurality of participants, the scene description.
Clause 12: A digital avatar repository (DAR) device for distributing extended reality (XR) media data, the DAR device comprising: means for receiving avatar data of a first XR session user; means for receiving a request to access the avatar data by a second XR session user; and means for sending the avatar data to a client device of the second XR session user.
Clause 13: A device executing a media function (MF) or multimedia resource function (MRF) and for distributing extended reality (XR) media data, the device comprising: means for receiving a scene description for an XR session between a first XR session user and a second XR session user, the scene description including data representative of avatar data for the first XR session user; means for receiving an animation stream from the first XR session user; and means for sending data representative of the animation stream and the avatar data to a client device of the second XR session user.
Clause 14: A computer-readable storage medium having stored thereon instructions that, when executed, cause a processor to perform the method of any of clauses 1-9.
Clause 15: A method of retrieving augmented reality (AR) media data, the method comprising: receiving, by a user equipment (UE) device engaged in an AR session, a scene description for the AR session from a device executing a media function or multimedia resource function (MF/MRF) of a radio access network (RAN) to which the UE device is communicatively coupled, the scene description including data representing how to access avatar data for one or more participants in the AR session; retrieving, by the UE device, the avatar data according to the scene description; and presenting, by the UE device, the avatar data to a user of the UE device during the AR session.
Clause 16: The method of clause 15, wherein the data indicating how to access the avatar data comprises data representing a network location of a digital asset repository (DAR) device storing the avatar data.
Clause 17: The method of clause 16, further comprising: obtaining user avatar data for the user of the UE device; and uploading the user avatar data for the user to the DAR device.
Clause 18: The method of clause 17, further comprising sending, to the DAR device, data indicating that the participants in the AR session are authorized to access the user avatar data.
Clause 19: The method of clause 16, wherein retrieving the avatar data comprises retrieving the avatar data from the DAR device.
Clause 20: The method of clause 15, further comprising: receiving an animation stream from one of the participants in the AR session; determining an avatar of the avatar data corresponding to the one of the participants; and animating the avatar according to the animation stream, wherein presenting the avatar data comprises presenting the animated avatar for the one of the of participants.
Clause 21: The method of clause 15, wherein retrieving the avatar data comprises receiving a media stream including animated avatar data for one of the participants in the AR session from the device executing the MF/MRF, and wherein presenting the avatar data comprises presenting the media stream.
Clause 22: A user equipment (UE) device for retrieving augmented reality (AR) media data, the UE device comprising: a memory configured to store media data of an AR session; and a processing system implemented in circuitry and configured to: receive a scene description for the AR session from a device executing a media function or multimedia resource function (MF/MRF) of a radio access network (RAN) to which the UE device is communicatively coupled, the scene description including data representing how to access avatar data for one or more participants in the AR session; retrieve the avatar data according to the scene description; and present the avatar data to a user of the UE device during the AR session.
Clause 23: The UE device of clause 22, wherein the data indicating how to access the avatar data comprises data representing a network location of a digital asset repository (DAR) device storing the avatar data.
Clause 24: The UE device of clause 23, wherein the processing system is further configured to: obtain user avatar data for the user of the UE device; and upload the user avatar data for the user to the DAR device.
Clause 25: The UE device of clause 24, wherein the processing system is further configured to send, to the DAR device, data indicating that the participants in the AR session are authorized to access the user avatar data.
Clause 26: The UE device of clause 23, wherein to retrieve the avatar data, the processing system is configured to retrieve the avatar data from the DAR device.
Clause 27: The UE device of clause 22, wherein the processing system is further configured to: receive an animation stream from one of the participants in the AR session; determine an avatar of the avatar data corresponding to the one of the participants; and animate the avatar according to the animation stream, wherein to present the avatar data, the processing system is configured to present the animated avatar for the one of the of participants.
Clause 28: The UE device of clause 22, wherein to retrieve the avatar data, the processing system is configured to receive a media stream including animated avatar data for one of the participants in the AR session from the device executing the MF/MRF, and wherein to present the avatar data, the processing system is configured to present the media stream.
Clause 29: A method of distributing augmented reality (AR) media data, the method comprising: receiving, by an AR application server (AS) device, data for each of a plurality of participants in an AR session indicating that the participant has an avatar to be presented in a scene corresponding to the AR session; generating, by the AR AS device, a scene description for the AR session, the scene description including data representing how to access avatar data for each of the plurality of participants; and sending, by the AR AS and to client devices of the plurality of participants, the scene description.
Clause 30: The method of clause 29, wherein sending the scene description comprises sending the scene description via a device executing a media function (MF) or a multimedia resource function (MFR).
Clause 31: The method of clause 29, wherein the data representing how to access the avatar data comprises data representing a network location of a digital asset repository (DAR) device storing the avatar data.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of retrieving augmented reality (AR) media data, the method comprising:
receiving, by a user equipment (UE) device engaged in an AR session, a scene description for the AR session from a device executing a media function or multimedia resource function (MF/MRF) of a radio access network (RAN) to which the UE device is communicatively coupled, the scene description including data representing how to access avatar data for one or more participants in the AR session;
retrieving, by the UE device, the avatar data according to the scene description; and
presenting, by the UE device, the avatar data to a user of the UE device during the AR session.

2. The method of claim 1, wherein the data indicating how to access the avatar data comprises data representing a network location of a digital asset repository (DAR) device storing the avatar data.

3. The method of claim 2, further comprising:
obtaining user avatar data for the user of the UE device; and
uploading the user avatar data for the user to the DAR device.

4. The method of claim 3, further comprising sending, to the DAR device, data indicating that the participants in the AR session are authorized to access the user avatar data.

5. The method of claim 2, wherein retrieving the avatar data comprises retrieving the avatar data from the DAR device.

6. The method of claim 1, further comprising:
receiving an animation stream from one of the participants in the AR session;
determining an avatar of the avatar data corresponding to the one of the participants; and
animating the avatar according to the animation stream,
wherein presenting the avatar data comprises presenting the animated avatar for the one of the of participants.

7. The method of claim 1, wherein retrieving the avatar data comprises receiving a media stream including animated avatar data for one of the participants in the AR session from the device executing the MF/MRF, and wherein presenting the avatar data comprises presenting the media stream.

8. The method of claim 1, wherein the avatar data comprises participant avatar data for a participant in the AR session different than a user of the UE device, the method further comprising uploading user avatar data for the user of the UE device to a digital avatar repository (DAR).

9. The method of claim 8, wherein the DAR comprises a first DAR, and wherein retrieving the participant avatar data comprises retrieving the participant avatar data from a second DAR.

10. A user equipment (UE) device for retrieving augmented reality (AR) media data, the UE device comprising:
a memory configured to store media data of an AR session; and
a processing system implemented in circuitry and configured to:
receive a scene description for the AR session from a device executing a media function or multimedia resource function (MF/MRF) of a radio access network (RAN) to which the UE device is communicatively coupled, the scene description including data representing how to access avatar data for one or more participants in the AR session;
retrieve the avatar data according to the scene description; and
present the avatar data to a user of the UE device during the AR session.

11. The UE device of claim 10, wherein the data indicating how to access the avatar data comprises data representing a network location of a digital asset repository (DAR) device storing the avatar data.

12. The UE device of claim 11, wherein the processing system is further configured to:
obtain user avatar data for the user of the UE device; and
upload the user avatar data for the user to the DAR device.

13. The UE device of claim 12, wherein the processing system is further configured to send, to the DAR device, data indicating that the participants in the AR session are authorized to access the user avatar data.

14. The UE device of claim 11, wherein to retrieve the avatar data, the processing system is configured to retrieve the avatar data from the DAR device.

15. The UE device of claim 10, wherein the processing system is further configured to:
receive an animation stream from one of the participants in the AR session;
determine an avatar of the avatar data corresponding to the one of the participants; and
animate the avatar according to the animation stream,
wherein to present the avatar data, the processing system is configured to present the animated avatar for the one of the of participants.

16. The UE device of claim 10, wherein to retrieve the avatar data, the processing system is configured to receive a media stream including animated avatar data for one of the participants in the AR session from the device executing the MF/MRF, and wherein to present the avatar data, the processing system is configured to present the media stream.

17. The UE device of claim 10, wherein the avatar data comprises participant avatar data for a participant in the AR session different than a user of the UE device, and wherein the processing system is configured to upload user avatar data for the user of the UE device to a digital avatar repository (DAR).

18. A method of distributing augmented reality (AR) media data, the method comprising:
receiving, by an AR application server (AS) device, data for each of a plurality of participants in an AR session indicating that the participant has an avatar to be presented in a scene corresponding to the AR session;
generating, by the AR AS device, a scene description for the AR session, the scene description including data representing how to access avatar data for each of the plurality of participants; and
sending, by the AR AS and to client devices of the plurality of participants, the scene description.

19. The method of claim 18, wherein sending the scene description comprises sending the scene description via a device executing a media function (MF) or a multimedia resource function (MFR).

20. The method of claim 18, wherein the data representing how to access the avatar data comprises data representing a network location of a digital asset repository (DAR) device storing the avatar data.
